(19) United States
(12) Patent Application Publication
(10) Pub. No.: US 2026/0360790 A1
(43) Pub. Date: Nov. 12, 2026

(54) METHOD AND DEVICE FOR TRANSPORTING FLAT ELECTRODE ELEMENTS

(71) Applicant: GIESECKE+DEVRIENT CURRENCY TECHNOLOGY GMBH, Munchen (DE)

(72) Inventors: Wolfgang KONIGER, Karlsfeld (DE); Michael FRESE, Neubiberg (DE); Frank NEUDEL, Freising (DE); Xaver THUM, Wolfratshausen (DE)

(21) Appl. No.: 19/120,847

(22) PCT Filed: Oct. 26, 2023
(86) PCT No.: PCT/DE2023/100795

§ 371 Date: Apr. 14, 2025

(30) Foreign Application Priority Data
Oct. 28, 2022 (DE) 10 2022 128 670.3

(51) Int. Cl. H01M 10/04; B65H 29/12; B65H 29/22; B65H 29/68

(52) U.S. Cl. CPC H01M 10/0404; B65H 29/125; B65H 29/22; B65H 29/68; B65H 2301/35; B65H 2301/4212; B65H 2301/542; B65H 2403/40; B65H 2513/20

(57) ABSTRACT

A device for transporting and optionally for stacking flat electrode elements, wherein the device is designed to transport the flat electrode elements individually one after another along a transport path. The device has a spacing increasing unit arranged along the transport path of the flat electrode elements, e.g. upstream of a stacking unit, and designed to increase the spacing of the flat electrode elements, in particular to a processing spacing, by accelerating the flat electrode elements to facilitate access to individual flat electrode elements from among the flat electrode elements.

### The invention relates to a method and a device for transporting and optionally for stacking flat electrode elements.

It is known to stack flat electrode elements for the production of electrochemical energy storage devices, such as lithium-ion batteries, or energy converters, such as fuel cells. Electrode elements are stacked particularly during the production of pouch cells, a widely used design of a lithium-ion rechargeable battery. The smallest unit of a lithium-ion cell usually consists of two electrode elements and a separator, which separates the electrode elements from one another. In a production line for electrochemical energy storage devices, e.g. for electrically driven motor vehicles, a multiplicity of such units, each separated by a further separator, are introduced into a casing, which is subsequently filled with an ion-conductive electrolyte and sealed.

Known methods for stacking the electrode elements rely on a gripping arm of a robot that grips and positions the electrode elements. Furthermore, it has been proposed to use a rotating stacker wheel for stack formation, the electrode elements being placed on an electrode stack by said stacker wheel. WO 2020/212316 A1 describes in this respect a method for producing an electrode stack of anodes and cathodes for a lithium-ion battery of an electrically driven motor vehicle, in which the anodes and the cathodes are conveyed into compartments of a rotating stacker wheel, and the anodes and cathodes received in the compartments are conveyed to a stack receptacle on the basis of the rotation of the stacker wheel.

In a production device for electrode elements, the latter are usually produced by being separated from a long material web and as a result are arranged with a small spacing between one another, this having arisen during the separating process. This separating spacing is usually in the mm range or less. On account of the small spacing between one another, the electrode elements have to be transported at a relatively low transport speed in order that mechanical access to each individual flat electrode element from among the flat electrode elements is possible, e.g. in order that the individual flat electrode elements, having been reliably separated from one another, can be introduced into the individual compartments of a rotating stacker wheel. It may even be necessary, if appropriate, that the transport of the respective flat electrode element upstream of the rotating stacker wheel must be slowed down or temporarily stopped in order to introduce the flat electrode elements into the stacker wheel after they have been reliably separated from one another.

If the flat electrode elements—for being introduced into different compartments of the stacker wheel after having been separated—are transported at a relatively low transport speed, it has been found that the flat electrode elements are not reliably transported into the stacker wheel.

It is an object of the invention to specify a method and respectively a device which make it possible for the individual flat electrode elements transported one after another to be able to be separated from one another more easily during their transport, and for example allow the successive flat electrode elements to be transported into compartments of a stacker wheel reliably and after having been separated from one another.

This object is achieved according to the invention by a method and a device as claimed in the independent claims. The dependent claims relate to advantageous embodiments of the invention.

In deliberations leading to the invention it was recognized that individual mechanical access to each individual one of the flat electrode elements transported one after another, e.g. in order to separate them from one another, is possible more easily if the spacing between the individual electrode elements is larger.

The invention therefore proposes increasing the spacing of the flat electrode elements transported one after another, or that is to say successive flat electrode elements. The increased spacing between the flat electrode elements transported one after another in a stream of flat electrode elements makes it possible more easily to mechanically separate the flat electrode elements from one another during their transport. This is because with increased spacing it is simpler to mechanically influence one of the flat electrode elements of the stream, without in so doing influencing the preceding or the succeeding electrode element. After the spacing has been increased, the flat electrode elements of the stream can be transported as necessary to different destinations, e.g. into different transport branches or into different compartments of a stacker wheel.

For example, the flat electrode elements transported one after another can be sorted more easily by virtue of the increased spacing, e.g. into different transport branches into which the transport path of the flat electrode elements branches downstream of the spacing increasing units. For example, one or more of the flat electrode elements can thus be sorted more easily out of the stream of flat electrode elements.

The device according to the invention has a transport unit designed to transport the flat electrode elements individually along a transport path, and a spacing increasing unit for increasing their spacing from one another. The flat electrode elements are accelerated by the spacing increasing unit, i.e. the transport speed of the flat electrode elements downstream of the spacing increasing unit is increased in comparison with the transport speed of the flat electrode elements upstream of the spacing increasing unit. In comparison with an increase in spacing by intermittent deceleration of the stream, e.g. by delaying the subsequent flat electrode element or by stop-and-go operation of the transport unit, the accelerating increase in spacing has the advantage that this avoids a decelerating repercussion on the production device for electrode elements which is disposed upstream of the device according to the invention and which makes the electrode elements available.

In particular, the invention proposes increasing the spacing of the successive flat electrode elements before stacking of the flat electrode elements or upstream of a stacker wheel used for stacking. By virtue of the increased spacing, the individual flat electrode elements can then be transported into different compartments of the stacker wheel more easily, after having been separated from one another. The increased spacing ensures that—even at the increased transport speed between the successive electrode elements—a sufficiently large time window is available for separately introducing the successive electrode elements into the different compartments of the stacker wheel.

In deliberations leading to the invention it was additionally recognized that introducing the flat electrode elements into the stacker wheel functions more reliably if said elements are introduced into the stacker wheel with a higher kinetic energy. The increased transport speed as a result of the acceleration allows the electrode elements to be transported into the stacker wheel more reliably. This is because the flat electrode elements then have a higher kinetic energy, i.e. sufficient momentum for the electrode elements to slide into the stacker wheel from the transport unit that transports the electrode elements toward the stacker wheel. In comparison with the kinetic energy of the flat electrode elements, the weight force or friction thereof is then of lesser importance, i.e. has a less disturbing effect on the movement of the flat electrode elements as they slide into the stacker wheel.

Preferably, the transport speed of the flat electrode elements in the device according to the invention is increased to a greater transport speed that is greater than at the input of the device. For example, this greater transport speed is maintained up to the stacking unit and the transporting of the respective electrode element into the stacker wheel. In particular, the transport speed of the flat electrode elements during transporting into the stacker wheel is preferably at least a factor of 1.1, particularly preferably at least a factor of 1.5, greater than the transport speed of the flat electrode elements at the output of that machine which is disposed upstream of the device according to the invention, e.g. at the output of the production device for electrode elements which is disposed upstream of the device according to the invention in a production installation for electrode stacks. By way of example, the transport speed of the flat electrode elements during transporting into the stacker wheel is at least 0.3 m/s, preferably at least 1 m/s.

By virtue of the increase in spacing, the leading edge-leading edge spacing of the successive flat electrode elements increases as well. Preferably, the increase in the leading edge-leading edge spacing of the successive flat electrode elements corresponds approximately to the increase in the transport speed, such that the transport rate (number of electrode elements/second) remains the same as before the increase in spacing, e.g. equal to the electrode element output rate of the machine disposed upstream of the device according to the invention in the production installation.

Hereinafter, the term flat electrode element is understood to mean an electrode element which has a much greater surface area in comparison with its thickness, e.g. its length and width are at least 10 times the thickness. For simplification, sometimes the term electrode element has been used instead of flat electrode element above and hereinafter, but a flat electrode element is always meant. The flat electrode elements are e.g. monocells, anodes, cathodes, separators, anode-separator combinations, cathode-separator combinations or anode-separator-cathode-separator combinations.

The device according to the invention can be designed for stacking flat electrode elements of a stream of flat electrode elements having a multiplicity of flat electrode elements. The or at least some successive flat electrode elements of the stream originate in particular from one and the same material web or were separated from one and the same material web by a separating device in a separating process.

For this purpose, the device according to the invention can have a stacking unit designed to stack the flat electrode elements, and having at least one rotatable stacker wheel with a plurality of stacker wheel compartments designed each to receive a flat electrode element. Moreover, the transport unit of the device can be designed to transport the flat electrode elements individually one after another along the transport path to the stacking unit and into the stacker wheel. In this way, it is possible to produce an electrode stack with flat electrode elements, e.g. of an electrochemical energy storage device or of an energy converter. Flat electrode elements of the same type, but also different flat electrode elements, can be stacked in the electrode stack.

The spacing increasing unit is designed to increase the spacing of the flat electrode elements, in particular to a processing spacing. The processing spacing to which the spacing of the flat electrode elements is increased by the spacing increasing unit is in particular at least 5 mm, preferably at least 10 mm, particularly preferably at least 20 mm. By way of example, the spacing increasing unit is arranged upstream of the stacking unit along the transport path of the flat electrode elements. The device can also have a plurality of identical or different spacing increasing units, e.g. in order to attain larger processing spacings.

The spacing increasing unit is designed to accelerate the flat electrode elements in order to increase the spacing thereof. By way of example, the spacing increasing unit is designed to carry out the increase in spacing or the acceleration by way of targeted mechanical influencing of the respective flat electrode element.

During transporting toward the spacing increasing unit, the flat electrode elements each have a separating spacing from one another, this having arisen as a result of the separation of the individual flat electrode elements from the material web. By virtue of the spacing increasing unit, the flat electrode elements each acquire a sufficiently large spacing or processing spacing from one another, which is greater than the separating spacing of the flat electrode elements by which the flat electrode elements were spaced apart during the separating process from a material web.

The spacing of the flat electrode elements is understood to mean the spacing between in each case two (in the stream) successive electrode elements, in particular the spacing between the trailing edge of a respective leading flat electrode element and the leading edge of a succeeding flat electrode element that in each case directly follows the leading flat electrode element. It is assumed that all or at least a multiplicity of the flat electrode elements of the stream have the same or approximately the same length. Therefore, with the spacing, as defined here, generally the leading edge spacing between the two leading edges of the successive flat electrode elements is increased as well, this spacing being important for the correct introduction of the successive flat electrode elements into the individual compartments of the stacker wheel.

Preferably, the spacing increasing unit increases the spacings of the successive flat electrode elements in such a way that, after passing through the spacing increasing unit, the processing spacing between the successive flat electrode elements is at least approximately identical for all or at least a multiplicity of successive flat electrode elements (of the stream). A uniformly high stack quality of the electrode stack produced from these flat electrode elements by the stacker wheel can be achieved as a result. Since generally the leading edge spacing between the leading edges of the successive flat electrode elements is also at least approximately identical as a result, uniform transporting of the electrode elements into the rotating stacker wheel is achieved, which further improves the stack quality.

However, the spacing increasing unit or a control unit of the spacing increasing unit can also be designed to produce different processing spacings between the electrode elements. In this regard, e.g. the processing spacing of low-quality electrode elements can be chosen to be greater than that of higher-quality electrode elements. This has the advantage that lower-quality electrode elements can be stacked or sorted out with greater reliability. In order to produce different processing spacings depending on the quality, information about the quality of the electrode elements—which applies to a plurality of electrode elements or individually to each electrode element—can be communicated to the control unit of the spacing increasing unit externally or from a sensor unit (arranged upstream of the spacing increasing unit along the transport path) of the device, which comprises one or more sensors, which is designed for detecting measurement signals of the flat electrode elements and derives therefrom information about the quality of the electrode elements.

For the case where the flat electrode elements should actually have different lengths, the spacing increasing unit can also be designed to produce different processing spacings between the electrode elements (between trailing edge and leading edge), preferably in such a way that the leading edge spacings of the between the successive flat electrode elements are at least approximately identical for all or at least a multiplicity of successive flat electrode elements (of the stream).

For the case where the leading edges of the flat electrode elements arrive at the spacing increasing unit at different points in time, the spacing increasing unit can also be designed to adapt the processing spacings between the electrode elements (between trailing edge and leading edge) in such a way that the leading edge spacings of the between the successive flat electrode elements are at least approximately identical for all or at least a multiplicity of the flat electrode elements transported one after another. Spacing corrections can be carried out in this way.

The transport unit of the device can be designed to transport the flat electrode elements into the (rotating) stacker wheel at a transport speed high enough that the kinetic energy of the respective flat electrode element is sufficient to ensure that the latter slides out of the transport unit into a stacker wheel compartment of the stacker wheel. Preferably, the flat electrode elements in this case slide into the respective stacker wheel compartment of the stacker wheel at least to the extent that the center of gravity or at least half of the length of the respective flat electrode element is contained in the respective stacker wheel compartment.

The rotatable stacker wheel is rotated about a stacker wheel axis during operation of the device, preferably at a uniform rotational speed. The stacker wheel has a plurality of stacker wheel fingers distributed over its circumference, and each compartment for receiving an electrode element is formed between respective fingers. The stacking unit can be designed to strip the electrode elements received in the compartments of the stacker wheel out of the respective compartment of the stacker wheel while the stacker wheel is rotating about its stacker wheel axis, wherein the electrode elements, as a result of being stripped out, are placed onto a receiving base, on which the electrode stack is formed. For this purpose, the stacking unit can have a stripper designed to strip out the electrode elements received in the compartments of the stacker wheel out of the respective compartment when the stacker wheel is rotating about its stacker wheel axis, wherein the electrode elements, as a result of being stripped out, are placed onto the electrode stack. Alternatively, the stripping out of the stacker wheel can also be effected without a stripper, e.g. by means of gravity. The device according to the invention optionally also has a stack receptacle designed to receive the electrodes stack.

The stacker wheel has (e.g. one or more disk-like) stacker wheel bodies which are rotatable about the stacker wheel axis and distributed over the circumference of which the stacker wheel fingers are arranged, wherein the stacker wheel fingers are each formed at the radial outer end of the stacker wheel body. The compartments of the stacker wheel are each delimited by two stacker wheel fingers. The stacker wheel fingers can be configured such that the compartments are arcuate, e.g. spiral-shaped, or have a straight shape, e.g. are slot-like. Preferably, the device has two or more stacker wheel bodies of identical type on the same axis of rotation, which are axially offset with respect to one another and e.g. rotate synchronously with one another.

It is also possible to use two or more than two transport units per stacker wheel, which are connected to the stacker wheel of the stacking unit at different angular positions. For example, cathodes and anodes can thus be fed to the same stacker wheel in a manner separated from one another, wherein the electrode elements (e.g. cathodes and anodes) transported there by the different transport units land alternately in the compartments of the stacker wheel and are placed on the same electrode stack.

In particular, the spacing increasing unit is designed to increase the spacing of the or of each two successive electrode elements while the or the respective two successive flat electrode elements are being transported through or past the spacing increasing unit. In this case, the flat electrode elements can be transported at least in part by means of the spacing increasing unit.

The spacing increasing unit is preferably designed to increase the spacing of the flat electrode elements by mechanically influencing the, in particular each of the individually successively transported, flat electrode elements.

Preferably, the spacing increasing unit is designed to accelerate a respective first flat electrode element, in particular each first flat electrode element which is transported downstream of a second flat electrode element directly succeeding said first flat electrode element along the transport path, relative to the second flat electrode element in order to increase the spacing thereof.

If the flat electrode elements arrive at the spacing increasing unit with a varying spacing between one another, the spacing increasing unit, in particular the control unit thereof and its acceleration unit (described below), can be designed to control the degree of acceleration of the respective first flat electrode element individually, e.g. depending on the respective spacing between the respective first flat electrode element and the respective second flat electrode element and optionally also depending on the respective spacing between the respective first flat electrode element and the flat electrode element leading the latter. For example, the spacing increasing unit or the acceleration unit thereof accelerates the respective first electrode element to a greater degree if the spacing between the latter and the second electrode element succeeding it is less than a lower limit spacing, and/or to a lesser degree if the spacing between said first electrode element and the second electrode element succeeding it is greater than an upper limit spacing. This control of the spacing increasing unit (e.g. of the acceleration unit) can be effected on the basis of a sensor (e.g. light barrier) which is disposed upstream of the spacing increasing unit and which measures the spacing of the successive flat electrode elements. Advantageously, the individual acceleration of the flat electrode elements makes it possible to attain a more uniform spacing of the flat electrode elements, which brings about a better stack quality of the electrode stack produced by the stacker wheel.

In some exemplary embodiments, the device in the region of the spacing increasing unit, e.g. the transport unit or the spacing increasing unit itself, along the transport path has at least one leading transport means and at least one succeeding transport means, which e.g. can each have at least one transport belt and/or at least one transport roller and/or at least one transport roller pair or a combination thereof. By way of example, the leading and/or succeeding transport means have transport belts or conveyor belts which lie opposite one another (e.g. run on rollers) and between which the electrode elements are clamped during transporting. The succeeding transport means makes available a greater transport speed for the flat electrode elements transported by means of it in comparison with the leading transport means. In particular, the leading and succeeding transport means are designed to transport the flat electrode elements in a frictional manner. The leading transport means makes available e.g. a first transport speed for the flat electrode elements transported by means of it, and the succeeding transport means makes available a second transport speed for the flat electrode elements transported by means of it, said second transport speed being greater than the first transport speed. Preferably, the second transport speed of the flat electrode elements is at least a factor of 1.1, particularly preferably at least a factor of 1.5, greater than the first transport speed. Preferably, the second transport speed of the flat electrode elements is at least 0.3 m/s, preferably at least 1 m/s.

In particular, the leading transport means is designed to transport the flat electrode elements to an acceleration region, in which the respective first flat electrode element is accelerated relative to the respective second flat electrode element, and the succeeding transport means is designed to transport the flat electrode elements away from the acceleration region, further along the transport path of the flat electrode elements, e.g. in the direction of the stacking unit or stacker wheel. The acceleration region is arranged between the leading and succeeding transport means, wherein the acceleration region can optionally overlap these transport means.

The acceleration of the leading electrode element increases the spacing with respect to the succeeding electrode element to the processing spacing mentioned above. After the acceleration, the electrode elements are transported further at the greater transport speed of the succeeding transport means. For example, they are transported at this greater transport speed through the entire device as far as the stacking unit and optionally into the stacker wheel.

Preferably, the spacing between a last engagement point of the leading transport means, e.g. of a first transport roller pair, and a first engagement point of the succeeding transport means, e.g. of a second transport roller pair, along the transport path of the flat electrode elements is greater than or equal to the length of the flat electrode elements along the transport path. This has the advantage that the succeeding transport means comes into engagement with the respective flat electrode element only when the latter is just passing out of engagement with the leading transport means or after said element has already passed out of engagement therewith. This allows gentle acceleration since the succeeding transport means does not then have to accelerate or transport the flat electrode elements counter to the frictional force of the leading transport means. Optionally, free-running rollers can additionally be used between the leading and succeeding transport means, on which the electrode elements are transported when they are neither in engagement with the leading transport means nor in engagement with the succeeding transport means.

In this case, the last engagement point of the leading transport means is that position along the transport path at which the flat electrode elements are last in engagement with the leading transport means during their movement along the transport path. Moreover the first engagement point of the succeeding transport means is that position along the transport path at which the flat electrode elements are first in engagement with the succeeding transport means during their movement along the transport path.

By way of example, the spacing between a last engagement point of the leading transport means and a first engagement point of the succeeding transport means is more than the length of the flat electrode elements, e.g. at least 1.5 times the length of the flat electrode elements along the transport path. There is then a portion of at least half the length of the electrode elements in which the latter are neither in engagement with the leading transport means nor in engagement with the succeeding transport means. As a result, an acceleration section is available which allows slower and thus even gentler acceleration. The acceleration in the acceleration section can be carried out by an acceleration unit arranged at the acceleration section or in the acceleration region or at the transition between the leading and succeeding transport means.

In some exemplary embodiments, the succeeding transport means is also used to accelerate the respective first flat electrode element, no additional acceleration unit being used.

In preferred exemplary embodiments, the spacing increasing unit has an acceleration unit arranged in the acceleration region or in the region of the transition between the leading and the succeeding transport means and designed to accelerate the respective first flat electrode element, when it is situated along the transport path between the leading and the succeeding transport means (and is transported to the succeeding transport means at the transition optionally by means of the leading transport means), relative to the leading transport means in order to increase the spacing of the respective first flat electrode element relative to the respective second flat electrode element. For example, the acceleration unit can temporarily impart an acceleration impulse to each flat electrode element which arrives at the transition between the leading and succeeding transport means, in order to accelerate said element from the speed of the leading transport means to the speed of the succeeding transport means. The acceleration unit achieves gentler acceleration of the flat electrode elements than in the case of acceleration solely by the succeeding transport means (without an acceleration unit present in addition thereto).

By way of example, the spacing increasing unit, in particular the succeeding transport means or the acceleration unit of the spacing increasing unit, is designed to accelerate the respective first flat electrode element relative to the second flat electrode element, by mechanically influencing the respective first flat electrode element, in order to increase their spacing. Preferably, the spacing increasing unit, in particular the succeeding transport means or the acceleration unit of the spacing increasing unit, is configured to begin the mechanical influencing of the respective first electrode element, said mechanical influencing being carried out for the purpose of increasing the spacing, at a point in time at which the respective second flat electrode element is (still) being transported by means of the leading transport means.

The succeeding transport means or the acceleration unit, in particular its mechanical influencing of the respective first flat electrode element, can be controlled in such a way that the degree of acceleration of the respective first flat electrode element is set individually, e.g. depending on the respective spacing between the respective first flat electrode element and the respective second electrode element and optionally depending on the respective spacing between the respective first flat electrode element and the flat electrode element leading the latter, e.g. as has been described above in connection with the limit spacings.

The acceleration unit can be configured to suck up or clamp the respective flat electrode element in order to transmit the force for acceleration to the respective electrode element.

In some exemplary embodiments, the acceleration unit has a (rotatable/rotating) transport roller pair arranged along the transport path in the region of the transition between the leading and succeeding transport means. The transport roller pair has at least one upper transport roller arranged above the transport path of the flat electrode elements and at least one lower transport roller arranged below the transport path of the flat electrode elements, the flat electrode elements being clamped between said transport rollers and the latter mechanically influencing a flat electrode element transported between them in order to accelerate it. For this purpose, only one or both of these transport rollers are driven by means of a drive.

In order to prevent a rotation of the electrode elements during the acceleration thereof, at least one further upper transport roller is arranged concentrically with respect to the upper transport roller (e.g. on the same drive shaft) and in a manner offset laterally with respect thereto and/or at least one further lower transport roller is arranged concentrically with respect to the lower transport roller (e.g. on the same drive shaft) and in a manner laterally offset with respect thereto, these forming a laterally offset further transport roller pair, between which the electrode elements are likewise clamped and which accelerate the electrode elements in the same way as the transport roller pair.

For example, the spacing between the acceleration unit, in particular the transport roller pair, and the leading transport means is chosen to be large enough that the electrode element is picked up by the acceleration unit (e.g. by being clamped between the transport rollers of the transport roller pair) only at the same time as or after the electrode element is withdrawn/has already been withdrawn from being clamped by the leading transport means. If this spacing is chosen to be greater than the electrode element length, it is optionally possible to use additional free-running rollers between the leading transport means and the acceleration unit, in particular the transport roller pair. Alternatively, the acceleration unit can, however, also pick up the respective electrode element as early as before the electrode element has left the leading transport means, e.g. the clamping thereby.

Usually, upon acceleration of the flat electrode elements relative to the leading transport means, when the leading transport means is still in engagement/frictional engagement with the flat electrode elements, the friction force of the leading transport means would counteract the acceleration of the flat electrode element and would mechanically stress the flat electrode elements. In order to minimize the mechanical stressing during acceleration, the leading transport means can be designed to transport the flat electrode elements in such an unfixed manner or with low enough static friction that the flat electrode elements, while they are being transported by the leading transport means, are able to be accelerated relative to the leading transport means, e.g. can be made to roll on or slide relative to the leading transport means, without being damaged in the process. By way of example, the leading transport means is designed to transport the flat electrode elements without holding on to them in the process, with regard to their relative movement relative to the leading transport means.

In order to transport the electrode elements in such an unfixed manner or with low enough static friction or without holding on to them,
the leading transport means can have one or more transport roller(s) or transport roller pair(s) provided with an integrated freewheel, or
the leading transport means can transport the electrode elements by means of a static friction force chosen at such a low level that they are able to be accelerated relative to the leading transport means or can be made to slide relative to the leading transport means, without being damaged in the process, or
the leading transport means can be designed to transport the flat electrode elements in a manner free of clamping, i.e. without clamping the flat electrode elements while they are being transported.

For transporting in a manner free of clamping, the leading transport means can be arranged only on one side of, for example beneath, the transport path. In other words, along the transport path, a transport means is arranged only on one side of/beneath the transport path in the region of the leading transport means. This may be e.g. a transport belt arranged only on one side of/beneath the transport path or one or more transport roller(s) arranged only on one side of/beneath the transport path, wherein (in relation to the transport path) on the opposite side from the leading transport means/above the transport path-at least directly upstream of the acceleration unit-there is no pressing element (such as for instance an opposite transport belt/transport roller) that presses the electrode element, in particular at the time of acceleration by means of the acceleration unit, against the leading transport means arranged on one side. The unfixed or clamping-free transporting by means of the leading transport means results in gentle acceleration/acceleration with only little mechanical stressing of the flat electrode elements.

If the leading transport means is designed to transport the flat electrode elements in an unfixed manner or with low static friction, it is possible without problems for the spacing between a last engagement point of the leading transport means and a first engagement point of the succeeding transport means or the spacing between a last engagement point of the leading transport means and the first engagement point of the acceleration unit along the transport path of the flat electrode elements to be chosen to be smaller than the length of the flat electrode elements along the transport path.

In one exemplary embodiment of the spacing increasing unit, the transport rollers of the transport roller pair each have a nonuniform radius which rises along the direction of rotation of the respective transport roller, once or more than once, from a first roller radius continuously along a ramp to a larger second roller radius (then optionally remains constant and afterward reverts abruptly or continuously to the first roller radius again). In this case, the first roller radius corresponds to the first transport speed of the flat electrode elements and the second roller radius corresponds to the second transport speed of the flat electrode elements. The transport rollers of the transport roller pair are rotated e.g. at a constant angular speed chosen such that the transport rollers make available the first transport speed of the flat electrode elements in the region of the first roller radius and the transport rollers make available the second transport speed of the flat electrode elements in the region of the second roller radius.

In other exemplary embodiments of the spacing increasing unit, the latter is designed to modulate the angular speed of the transport rollers of the transport roller pair in order to accelerate the electrode elements. In particular, the angular speed of one or more upper and/or one or more lower transport rollers of the spacing increasing unit is modulated such that the transport speed of the respective electrode element is changed from the first to the second transport speed by the action of the transport rollers. By way of example, the angular speed of the transport rollers of the transport roller pair is modulated so that the path speed of the transport rollers is varied periodically, in particular between exactly or approximately the first transport speed and exactly or approximately the second transport speed of the flat electrode elements. In this case, the transport rollers of the transport roller pair each preferably have a uniform radius. The path speed of the transport rollers is in this case increased, preferably continuously, from the first transport speed to the second transport speed of the flat electrode elements and is then reduced again to the first transport speed in order to be ready for accelerating the next electrode element.

In one of these exemplary embodiments of the spacing increasing unit, the modulation of the angular speed is achieved by virtue of the transport roller pair being driven via at least one non-circular gearwheel with a (smoothly running) drive, wherein the modulation of the angular speed is achieved e.g. by a non-concentric transmission coupling between the drive and the transport roller pair.

In another of these exemplary embodiments of the spacing increasing unit, the modulation of the angular speed is achieved by virtue of one or both transport rollers of the transport roller pair being driven by means of a modulatable rotary drive, e.g. by means of a variable-speed motor. In this case, the time of the modulation is preferably controlled depending on the time at which the electrode element to be accelerated arrives at the transition between the leading and succeeding transport means, in particular by means of at least one sensor (e.g. a light barrier) which detects the arrival of the electrode element to be accelerated at the transition. Preferably, the sensor is positioned at the transition such that it registers the leading edge of the respective flat electrode element when the latter is just passing out of engagement or has passed out of engagement with the leading transport means. In this case, the sensor detects the leading edge preferably between the last engagement point of the leading transport means and the clamping point of the transport roller pair.

In a further exemplary embodiment of the spacing increasing unit, the acceleration unit has a suction transport belt arranged above the transport path of the flat electrode elements and designed to lift off an electrode element, which is being transported at the first transport speed to the transition by the leading transport means, from the leading transport means by suction, to accelerate said electrode element upon and/or during the suction, in particular from the first transport speed to the second transport speed or a transport speed therebetween, and to place it on the succeeding transport means after the acceleration, in particular when it has accelerated the electrode element to the second transport speed or the transport speed therebetween. Optionally, the suction transport belt can overlap the leading and/or the succeeding transport means along the transport path of the electrode elements.

In order to accelerate one or more flat electrode elements individually to a higher degree than others, the second transport means or the transport roller pair or the suction transport belt can briefly make available a transport speed for the relevant flat electrode element(s) that is increased even further than that for the other flat electrode elements (which do not require higher acceleration and are subjected to the normally increased transport speed). For accelerating one or more flat electrode elements individually to a lesser degree, a transport speed that is increased to a lesser extent is accordingly made available.

In the method according to the invention and respectively with the device according to the invention, the flat electrode elements, e.g. before their stacking, can optionally be sorted as well. In one exemplary embodiment for this purpose the device has a sensor unit comprising one or more sensors designed for detecting measurement signals of the flat electrode elements. The sensor unit is arranged upstream of a sorting unit along the transport path of the electrode elements. The detecting is preferably effected while the flat electrode elements are being transported past the sensor unit. The device then additionally comprises an evaluation unit designed for checking the flat electrode elements on the basis of the measurement signal detected for the respective flat electrode element, by means of at least one checking criterion, e.g. with regard to the quality of the electrode element. The checking can comprise an optical check and/or an electrical check of the electrode elements. The evaluation unit is designed, upon checking the respective flat electrode element, to generate a checking result indicating whether or not the respective flat electrode element satisfies the at least one checking criterion.

The device designed for sorting the electrode elements additionally has a sorting unit arranged downstream of the sensor unit along the transport path and designed for sorting the flat electrode elements depending on the respective checking result. The sorting unit is designed in particular to sort out of the stream those flat electrode elements for which the respective checking result indicates that they do not satisfy the at least one checking criterion, and to leave the other flat electrode elements (those flat electrode elements which satisfy the at least one checking criterion) in the stream of the flat electrode elements (which is transported e.g. to the stacking unit).

The transport unit is designed to transport the flat electrode elements individually one after another along the transport path to the sensor unit, afterward to the sorting unit and optionally afterward to a stacking unit. By way of example, the sorting unit has at least one diverter which is designed to selectively sort individual flat electrode elements from among the flat electrode elements out of the stream. Preferably, the transport path of the flat electrode elements between the sensor unit and the sorting unit has an evaluation section, wherein the evaluation unit is designed to check the flat electrode elements at least in part while they are being transported along the evaluation section.

Preferably, the spacing increasing unit is arranged upstream of the sorting unit, as viewed along the transport path of the flat electrode elements. In particular, the spacing increasing unit can be arranged directly upstream of the sorting unit along the transport path of the flat electrode elements. Alternatively, along the transport path of the flat electrode elements, a transport portion for the flat electrode elements and/or the sensor unit and/or some other unit can be present between the spacing increasing unit and the sorting unit. If the spacing increasing unit is arranged upstream of the sorting unit, this has the advantage that, even at an increased transport speed, reliable sorting out or branching off of an individual electrode element into a different transport branch is possible, since the sorting unit, e.g. the diverter thereof, can mechanically take hold of only one specific one of the successive electrode elements more reliably without adversely affecting the transporting past (non-sorting out) of the respectively succeeding or preceding electrode element.

Preferably, the spacing increasing unit is arranged upstream of the sensor unit (directly upstream of the latter or with an intervening portion) along the transport path of the flat electrode elements. As a result, the spacing between the electrode elements is increased even before the measurement signals are detected. The increased spacing results in more reliable separation of the measurement signals of successive flat electrode elements. As an alternative thereto, however, the spacing increasing unit can also be arranged downstream of the sensor unit along the transport path of the flat electrode elements, wherein it is then preferably arranged between the sensor unit and the sorting unit. In principle, however, the spacing increasing unit can also be arranged downstream of the sorting unit, e.g. between the sorting unit and the stacking unit.

Preferably, the device has a control unit designed to control the transport unit for transporting the flat electrode elements and the sorting unit for sorting out individual flat electrode elements, e.g. the switching of the diverter in order optionally to sort out individual flat electrode elements from among the flat electrode elements. The control unit can, if necessary, also control the spacing increasing unit or acceleration unit for increasing the spacing of the flat electrode elements, e.g. the timing thereof, e.g. depending on the arrival time of the respective flat electrode element or the leading edge thereof at the spacing increasing unit or depending on the arrival time at the transition between the leading and the succeeding transport means. Alternatively, however, the spacing increasing unit or acceleration unit can also run permanently, without the need for control individually for the individual flat electrode elements.

The invention also relates to a method for transporting, and optionally for stacking, flat electrode elements, in particular with the aid of the device described above, from a stream of flat electrode elements having a multiplicity of flat electrode elements. The flat electrode elements of the stream, e.g. in a unit disposed upstream of the device, were separated from a or the same material web by a separating device in a separating process, wherein at least some successive flat electrode elements were separated from one and the same material web. In the stream the electrode elements have a separating spacing between one another which the flat electrode elements acquired during the separating process carried out on the material web by the separating device.

In particular, the stream of the flat electrode elements is produced with the aid of the following steps:
providing a material web, along the longitudinal direction of which a plurality of flat electrode elements are arranged (e.g. directly successively), and
transporting the material web to a separating device and separating the individual flat electrode elements from the material web by way of the separating device in the context of a separating process, wherein during the separating process the flat electrode elements are spaced apart from one another in each case by a separating spacing caused by the separating process. The separating spacing corresponds in particular to the width of a separating line along which the flat electrode elements are separated from the material web during the separating process. This spacing is generally less than 5 mm and can even be less than 0.1 mm.

In the method, the flat electrode elements of the stream are transported individually one after another along a transport path with the aid of at least one transport unit to a spacing increasing unit, which increases the spacing of the flat electrode elements by accelerating the flat electrode elements, in particular from the separating spacing to a processing spacing.

After the spacing has been increased, the flat electrode elements can be transported to different destinations, e.g. into different transport branches into which the transport path of the flat electrode elements branches downstream of the spacing increasing units. For example, one or more of the flat electrode elements can thus be sorted more easily out of the stream of flat electrode elements.

Alternatively or additionally, after the spacing has been increased, the electrode elements can be transported to a stacking unit designed to stack the flat electrode elements. The stacking unit has e.g. at least one rotatable stacker wheel with a plurality of stacker wheel compartments designed each to receive a flat electrode element. The flat electrode elements, in particular by means of the transport unit, are transported to a spacing increasing unit, which increases the spacing of the flat electrode elements by accelerating the flat electrode elements, in particular from the separating spacing to a processing spacing. This is carried out e.g. before the stacking by the stacking unit. In this case, the spacing increasing unit is arranged upstream of the stacking unit or upstream of the stacker wheel—as viewed along the transport path. The processing spacing acquired by the flat electrode elements by virtue of the spacing increasing unit is greater than the separating spacing of the flat electrode elements which the flat electrode elements acquired during the separating process carried out on the material web by the separating device.

The stacking unit has e.g. at least one rotatable stacker wheel with a plurality of stacker wheel compartments designed each to receive a flat electrode element. The stacking by means of the stacker wheel comprises the following steps, for example:
transporting a respective electrode element into a respective compartment of the stacker wheel rotating about the stacker wheel axis, in particular at the greater/second transport speed mentioned above, and
stripping the electrode elements received in the compartments of the stacker wheel out of the respective compartment of the stacker wheel, optionally by means of a stripper, while the stacker wheel is rotating about its stacker wheel axis, wherein the electrode elements, as a result of being stripped out, are placed onto an electrode stack arranged e.g. on a receiving base of the stacking unit.

In one preferred method, the electrode elements can be transported individually one after another along the transport path to a sensor unit, to a sorting unit, and then, if present, to the abovementioned stacking unit, wherein the following steps are carried out:
transporting the flat electrode elements of the stream to the sensor unit and detecting measurement signals of the flat electrode elements by way of the sensor unit, e.g. while the flat electrode elements are being transported past the sensor unit,
checking the flat electrode elements on the basis of the measurement signal detected for the respective flat electrode element, by means of at least one checking criterion, in particular with regard to their quality, wherein upon the checking of the respective flat electrode element, a checking result indicating whether or not the respective flat electrode element satisfies the at least one checking criterion is generated; preferably, the flat electrode elements are transported further in the direction of the sorting unit during the checking,
transporting the flat electrode elements to the sorting unit and sorting the flat electrode elements by way of the sorting unit depending on the respective checking result, wherein the sorting unit sorts out of the stream those flat electrode elements for which the checking results indicate that they do not satisfy the at least one checking criterion, and leaves the other flat electrode elements (those flat electrode elements which satisfy the at least one checking criterion) in the stream of the flat electrode elements,
and optionally transporting the flat electrode elements, in particular the flat electrode elements left in the stream after the sorting, to the stacking unit arranged downstream of the sorting unit, said stacking unit being designed to stack the flat electrode elements in order to produce an electrode stack with the flat electrode elements (and optionally further elements).

In the method, the flat electrode elements, before the stacking by the stacking unit, are transported to the spacing increasing unit, which increases the spacing of the flat electrode elements, in particular from the separating spacing to the processing spacing. In one particularly preferred method, the flat electrode elements are transported to the spacing increasing unit as early as before the sorting by the sorting unit and particularly preferably also before the checking by the checking unit.

The advantages presented with regard to the device according to the invention apply, mutatis mutandis, to the method according to the invention. Further features of the invention are evident from the claims, the figures and the description of the figures. Exemplary embodiments of the invention will be explained in more detail below with reference to a schematic drawing, in which:

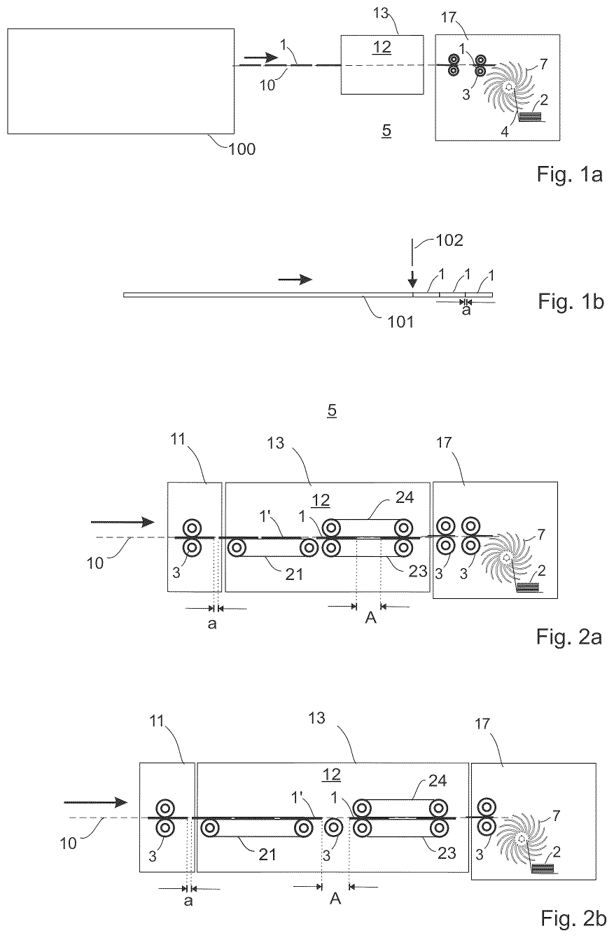

FIG. 1a shows a first exemplary embodiment of a device for transporting and stacking flat electrode elements with a spacing increasing unit,

FIG. 1b schematically shows the separation of the individual electrode elements from a material web,

FIGS. 2 a, b show a first and a second exemplary embodiment of a spacing increasing unit,

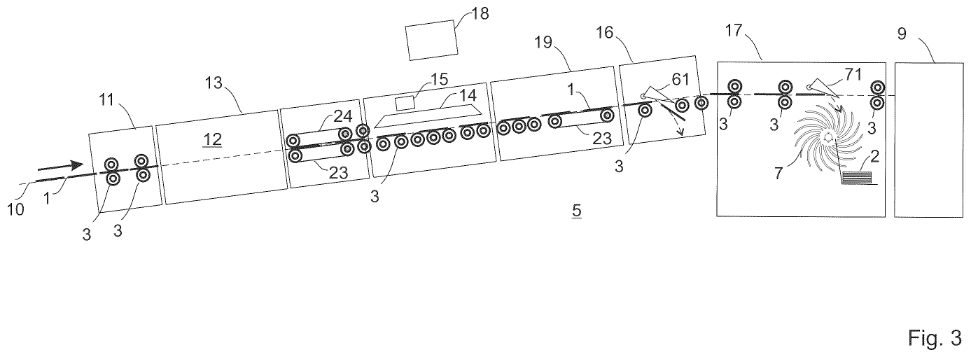

FIG. 3 shows a second exemplary embodiment of a device for transporting and optionally for stacking flat electrode elements with a spacing increasing unit, a sensor unit and a sorting unit,

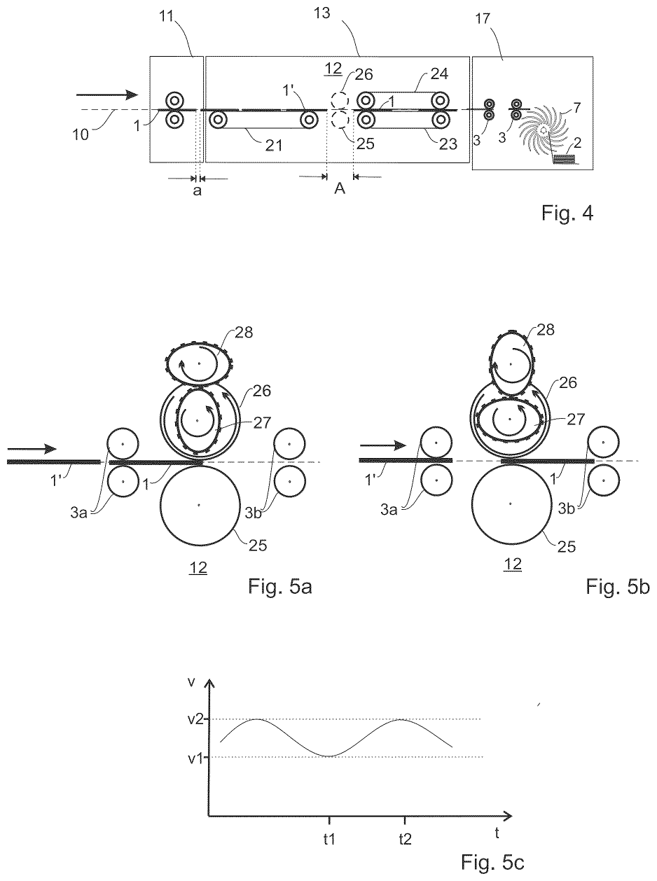

FIG. 4 shows an overarching principle of a third, a fourth and a sixth exemplary embodiment of the spacing increasing unit,

FIGS. 5 a, b, c show a third exemplary embodiment of a spacing increasing unit,

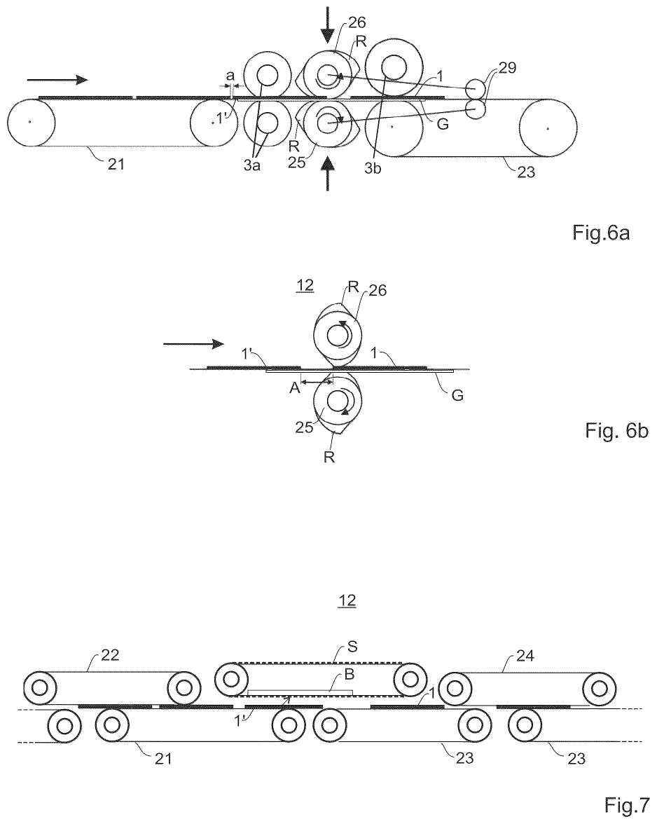

FIGS. 6 a, b show a fourth exemplary embodiment of a spacing increasing unit,

FIG. 7 shows a fifth exemplary embodiment of a spacing increasing unit,

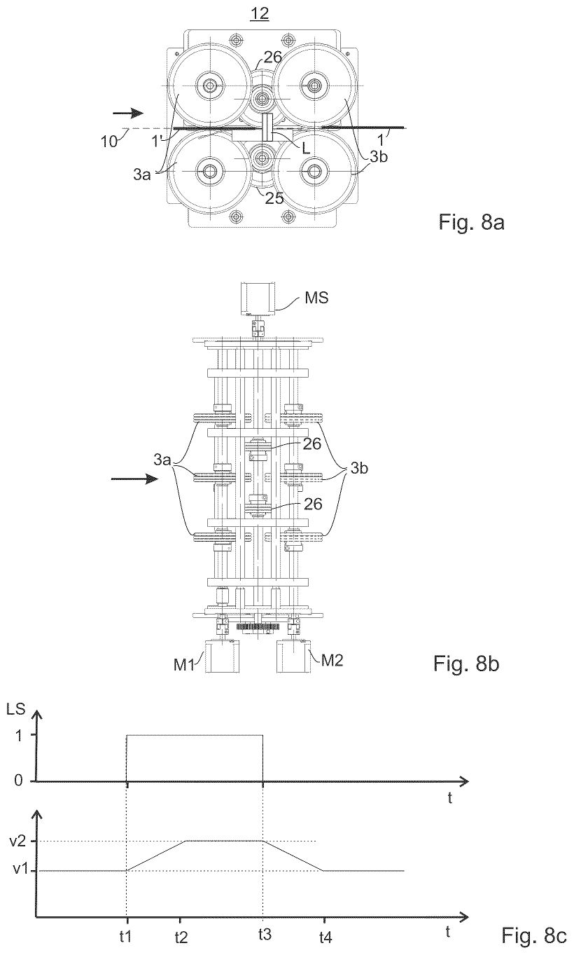

FIG. 8 shows a sixth exemplary embodiment of a spacing increasing unit.

FIG. 1 shows a first exemplary embodiment of a device 5 for transporting and for stacking flat electrode elements. Disposed upstream of the device 5 is a production device 100 for flat electrode elements 1, which produces a stream of flat electrode elements 1 that are transported from the production device 100 to the device 5 for stacking the electrode elements. The flat electrode elements can be fuel cells or battery cells or constituent parts thereof that are used for the production thereof.

The production device 100 uses a continuous material web 101, along the longitudinal direction of which are arranged continuously a plurality of flat electrode elements 1, which are directly adjacent to one another. The material web can comprise one or more layers, e.g. at least one separator layer, on which one or more cathode layers and/or anode layers are applied, e.g. alternately. By way of example, a plurality of cathodes and anodes are separated from one another by separator layers. The material web can comprise e.g. the layer sequence anode-separator-cathode-separator.

In the production device 100, the material web 101 is transported to a separating device 102, which separates the individual flat electrode elements 1 from the material web 101, e.g. by cutting or stamping or lasering. In the context of this separating process, the flat electrode elements 1 are spaced apart from one another in each case by a separating spacing a, caused only by the separating process. The separating spacing a corresponds to the width of a separating line (cf. FIG. 1b) along which the flat electrode elements are separated from the material web during the separating process. The separating spacing a may be governed e.g. by the width of the separating tool used during the separating process and is usually less than 5 mm. In the case of a laser cut or shearing off, it is e.g. <0.1 mm.

The stream of flat electrode elements provided by the production device 100 therefore comprises a multiplicity of flat electrode elements 1 which were separated from the same material web 101. For example, the flat electrode elements are individual anodes, individual cathodes, anode-separator combinations or cathode-separator combinations, e.g. half-cells, or anode-separator-cathode-separator combinations, e.g. monocells.

In the device 5, the stream of flat electrode elements 1 is transported by means of a transport unit along a transport path 10 as far as a stacking unit 17. The transport unit has e.g. a plurality of transport rollers 3 and/or opposite transport belts, which run around rollers and between which the flat electrode elements are clamped and transported.

The stacking unit 17 has a stacker wheel 7, which is rotatable about a stacker wheel axis, with a plurality of stacker wheel compartments designed each to receive a flat electrode element. The stacker wheel 7 has a plurality of stacker wheel fingers distributed in each case over the circumference of the stacker wheel, between which a respective compartment for receiving an electrode element 1 is formed. Said stacker wheel is rotated about its axis by means of a motor such that a respective electrode element 1 is inserted into a respective compartment of the respective stacker wheel 7 by means of the transport unit. By way of a stripper 4, the electrode element 1 received in the respective compartment can be stripped out of the stacker wheel 7 so as to be placed onto a stack 2. The stacker wheel fingers and compartments here extend spirally around the axis of rotation, but can alternatively also be formed in a straight manner, e.g. in a radial manner, and optionally have a greater compartment width than illustrated, in order that the electrode elements 1 are not bent by the shape of the compartment.

Along the transport path 10, a spacing increasing unit 12 is arranged upstream of the stacking unit 17, and is configured to increase the spacing between the or all flat electrode elements from the separating spacing a, this having arisen as a result of the separation from the material web, to a processing spacing A that is greater than the separating spacing a. Preferably, the processing spacing A is at least 20 mm. The spacing increasing unit 12 is arranged e.g. in a module 13 of the device.

Before the stacking, further processing steps can be carried out on the electrode elements 1 in the device 5, e.g. a quality inspection and optionally sorting of electrode elements out of the stream. Examples of further processing steps are described in the exemplary embodiment pertaining to FIG. 3.

The spacing between each two successive electrode elements 1 is increased while the respective two flat electrode elements are being transported through or past the spacing increasing unit 12. In order to increase the spacing of the respective two successive electrode elements, the leading electrode element 1 is accelerated relative to the electrode element 1′ succeeding it, in the spacing increasing unit 12. For this purpose, the spacing increasing unit 12, along the transport path 10, preferably has at least one leading transport means and at least one succeeding transport means, wherein the succeeding transport means makes available a greater transport speed for the flat electrode elements transported by means of it, in comparison with the leading transport means.

FIG. 2a shows a first exemplary embodiment of the spacing increasing unit 12. In the case of the device 5 in FIG. 2a, the stream of flat electrode elements 1 arrives e.g. in an input region 11, from which it is transported to the spacing increasing unit 12 and then to the stacking unit 17. In the spacing increasing unit 12, a transport belt 21 is used as a leading transport means and a transport belt pair 23, 24 is used as a succeeding transport means. The transport belts 21 and 23, 24 run at a constant speed, wherein the succeeding transport belt pair 23, 24 runs faster than the leading transport belt 21. At the transition between the slower transport belt 21 and the faster transport belt pair 23, 24, the flat electrode elements 1, as soon as they come into mechanical engagement with the faster transport belt pair 23, 24, are gripped by means of frictional engagement and are accelerated jerkily and are transported further in the direction of the stacking unit 17 at the greater transport speed of the transport belt pair 23, 24. As a result of the acceleration of the first, leading electrode element 1, the spacing from the second, succeeding electrode element 1′ increases to a processing spacing A, cf. FIG. 2a. The transport belt 21 transports the flat electrode elements in a manner free of clamping, i.e. without an opposite pressing element, in order that the electrode elements do not have to be accelerated counter to a high frictional force (associated with clamping) by means of the transport belt pair 23, 24.

FIG. 2b shows a modification of the first exemplary embodiment, in which the transport belt 21 is spaced apart from the transport belt pair 23, 24 by more than the electrode element length, in order that the respective flat electrode element is no longer slowed by the frictional force of the transport belt 21 at the time of acceleration. Arranged in between is a transport roller 3 mounted in a free-running manner in order to facilitate the acceleration by means of the transport belt pair 23, 24. Instead of the transport belts 21, 23, 24, transport rollers can also be used in the exemplary embodiment in FIGS. 2a, 2b.

FIG. 3 shows a second exemplary embodiment of a device 5 for transporting electrode elements. The device 5 has, along the transport path downstream of an input region 11 and downstream of a spacing increasing unit 12, a sensor unit 14 comprising one or more sensors that detect measurement signals of the flat electrode elements, e.g. for the quality inspection thereof. By way of example, an image of and optionally electrical signals from the electrode elements are captured and evaluated in this case. An evaluation unit 15 checks the flat electrode elements on the basis of the detected measurement signals by means of at least one checking criterion and generates a checking result for the respective flat electrode element, indicating whether or not the respective flat electrode element satisfies the at least one checking criterion. Downstream of the sensor unit 14, the flat electrode elements 1 are transported further to a sorting unit 16, which is arranged downstream of the sensor unit along the transport path and is designed for sorting the flat electrode elements depending on the respective checking result. The sorting unit has a diverter 61 designed to selectively sort individual flat electrode elements from among the flat electrode elements out of the stream. An evaluation section 19 is situated between the sensor unit 14 and the sorting unit 16. The evaluation unit 15 checks the flat electrode elements while they are being transported along the evaluation section 19. The flat electrode elements are transported individually one after another along the transport path, by means of the transport units 3, 23, 24, to the sensor unit 14, the sorting unit 16 and then via a diverter 71 selectively to the stacking unit 17 or past the latter, e.g. to a further unit 9 of the device.

The device 5 also has a control unit 18, which acquires the respective checking result from the evaluation unit 15 and controls the sorting unit 16 for sorting out individual flat electrode elements depending on the respective checking result. The control unit 18 also controls the transport units 3, 23, 24 and optionally also the spacing increasing unit 12.

Alternatively, the device 5 of the second exemplary embodiment can also be realized without a stacking unit 17, such that the electrode elements not sorted out in the sorting unit 16 are transported to the further unit 9 of the device. The devices 5 of the other exemplary embodiments can also be realized without a stacking unit 17 and the electrode elements are instead transported to some other unit.

FIG. 4 shows the overarching principle of a third, a fourth and a sixth exemplary embodiment of the spacing increasing unit 12. Here an acceleration unit is additionally arranged in a transition region between the leading transport means 21 and the succeeding transport means 23, 24, said acceleration unit in this case having a rotatable, driven transport roller pair comprising two transport rollers 25, 26 situated opposite each other. Said transport rollers mechanically influence a flat electrode element 1 transported between them in order to accelerate it and, as a result, to increase the spacing from the second electrode element 1′ succeeding it. Instead of transport belts 21, 23, 24, transport rollers can also be used in these exemplary embodiments. In order to prevent a rotation of the electrode elements during the acceleration thereof, at least one further transport roller 25 is arranged on the shaft of the transport roller 25 and at least one further transport roller 26 is arranged on the shaft of the transport roller 26, which further transport rollers can be identical to the transport rollers 25 and 26, respectively, and are used for accelerating the electrode elements. The third, fourth and sixth exemplary embodiments, all of which use a transport roller pair, can also be combined with one another. For example, the transport rollers 25, 26 of the third and fourth exemplary embodiments can be modulated in terms of their angular speed in accordance with the sixth exemplary embodiment, in order to assist the acceleration.

FIGS. 5 a, b, c illustrate a third exemplary embodiment of the spacing increasing unit 12, which embodiment follows the principle shown in FIG. 4. FIGS. 5a and 5b show the spacing increasing unit at two different points in time t1 and t2. FIG. 5c shows the temporal profile of the angular or path speed of the accelerating transport roller pair 25, 26. In FIGS. 5 a, b, the transport rollers 25, 26 of the transport roller pair each have a uniform radius. The angular speed and thus also the path speed of at least one of the transport rollers 25, 26 of the transport roller pair are modulated by virtue of the transport rollers being driven with the aid of two non-circular gearwheels 27, 28, which can have e.g. an oval or elliptic shape. The first gearwheel 27 is seated fixedly on the shaft of the transport roller 26 and engages with a second gearwheel 28, which is seated on a drive shaft driven at a uniform speed. The gearwheel 28 is driven at a constant angular speed by the drive shaft, but has an oscillating path speed on account of its shape and transmits that to the gearwheel 27 and thus also to the transport roller 26. The direction of rotation of the gearwheels and of the transport roller 26 is indicated by arrows in FIGS. 5a and 5b. The transport roller 25 situated opposite the speed-modulated transport roller 26 is a free-running roller.

On account of this non-concentric transmission coupling, at the transport roller 26 a low path speed v1 is generated at the first point in time t1, shown in FIG. 5a, and a higher path speed v2 is generated at the second point in time t2, shown in FIG. 5b. If the motor that drives the gearwheel 28 has a constant drive speed, an oscillating output is generated via the non-concentric, e.g. elliptic, coupling of the two gearwheels 27, 28. As a result, the path speed of the transport roller 26 is modulated between the first path speed v1 and the second path speed v2, cf. FIG. 5c. The angular position of the gearwheels 27, 28 is chosen such that, at the coupling point of the two gearwheels, a small radius of the gearwheel 28 meets a large radius of the gearwheel 27. As a result, the modulation of the path speed has an even greater effect on the angular speed of the gearwheel 27 and the transport roller 26. For finely adjusting the change in speed, the angular position of the gearwheel 28 can be varied relative to the gearwheel 27. In order to prevent a rotation of the electrode elements during the acceleration thereof, at least one further such transport roller 26 is arranged on the shaft of the transport roller 26 and used for accelerating the electrode elements 1.

A flat electrode element 1 that is clamped between the two transport rollers 25, 26 at the point in time t1 is thus accelerated from the first to the second path speed. The first path speed v1 of the transport roller 26 in this case corresponds e.g. to the transport speed of the transport rollers 3a that transport the electrode element 1 toward the transport rollers 25, 26, and the second path speed v2 of the transport roller 26 in this case corresponds e.g. to the transport speed of the transport rollers 3b that transport the electrode elements 1 further downstream of the transport rollers 25, 26. Although the transport rollers 3a are driven, they are equipped with a freewheel which allows the electrode element to be taken out of their clamping without resistance.

FIGS. 6 a, b illustrate a fourth exemplary embodiment of the spacing increasing unit 12, which embodiment follows the principle shown in FIG. 4. FIGS. 6a and 6b show the spacing increasing unit at two different points in time t1 (FIG. 6a) and t2 (FIG. 6b), wherein the transport belts 21, 23 and transport rollers 3a, 3b have been omitted in FIG. 6b for simplification purposes.

The electrode elements 1 are transported there with a spacing a on a transport belt 21 arranged on one side, cf. FIG. 6a. Arranged above and below the transport path are two driven transport rollers 3a, the path speed of which corresponds to the circumferential speed of the transport belt 21. Although the transport rollers 3a are driven, they are equipped with a freewheel which allows the electrode element to be taken out of their clamping without resistance. Located downstream thereof along the transport path (arrow) are a pair of shafts, on which are seated two transport rollers 25, 26 of a transport roller pair, which each have a nonuniform radius and are driven at a constant angular speed via a drive 29, e.g. a belt or gearwheel. This is followed by the transport belt 23, which transports the electrode elements 1 further at the higher speed. Optionally, a further transport roller 3b is arranged opposite the transport belt 23.

The radius of the transport rollers 25, 26 rises along the direction of rotation thereof continuously from a first roller radius to a larger second roller radius, such that they have a ramp R along their circumference. The transport rollers 25, 26 have the path speed of the transport belt 21 at the smaller first roller radius, and the higher path speed of the transport belt 23 at the larger second roller radius. If an electrode element 1 is then clamped between the transport rollers 25, 26, it is accelerated on account of the roller radius of the transport rollers that rises along the ramp R; cf. FIG. 6 b. This results in a greater spacing A between the accelerated electrode element and the succeeding electrode element. The two shafts of the transport rollers 25, 26 are spring-loaded perpendicularly to the transport plane of the electrode elements in order that these can yield to the rising roller radius at the clamping point.

The ramp R may be constituted such that, in the course of the rise in the roller radius, it has a segment in which the transport rollers 25, 26 constantly have the larger second roller radius. As an alternative or in addition to the segment with the constant larger second roller radius, the transport rollers 25, 26 can be equipped with an integrated freewheel allowing the electrode element 1 to be removed by the transport belt 23 without resistance.

The angular position of the transport rollers 25, 26 is chosen such that, at the time at which the electrode element 1 arrives at the clamping point, the small diameter of the transport rollers 25, 26 is located in each case at the clamping point of the electrode element 1. The removal of the respective electrode element 1 by the faster transport belt 23 takes place e.g. in each case at a time at which the larger diameter of the transport rollers 25, 26 is located at the clamping point. The respective electrode element 1 already passes out of engagement with the transport roller pair 25, 26 in the direction of the transport belt 23 before it comes back into engagement with the smaller first roller radius. This can be achieved by virtue of the fact that, during the rotation of the transport roller pair 25, 26, a specific phase position is chosen for the arrival of the electrode element, at which the end of the ramp R comes into engagement only with the rear region of the respective electrode element.

In the acceleration region of the electrode elements, a sliding plate G is optionally arranged directly below the transport path 10, said sliding plate serving to guide the electrode elements while this is accelerated by means of the transport roller pair 25, 26. In order to prevent the electrode elements from rotating while they are being accelerated, preferably at least one further such transport roller 25 is arranged on the shaft of the transport roller 25 and in phase with the latter and at least one further such transport roller 26 is arranged on the shaft of the transport roller 26 and in phase with the latter, and these are used to accelerate the respective electrode element.

FIG. 7 shows a fifth exemplary embodiment of the spacing increasing unit 12. In this case—unlike in FIG. 4—a suction transport belt S is used as the acceleration unit between the slower leading transport means and the faster succeeding transport means, said suction transport belt being arranged in the region of the transition between a leading transport belt 21 and a succeeding transport belt 23. An electrode element 1 that is transported there at a first transport speed by means of the transport belt 21 is lifted off the transport belt 21 by suction by means of the suction transport belt S. The suction transport belt S overlaps the first and second transport belts 21, 23 along the transport path and runs at a constant speed which is greater than the first transport speed. Along its entire length, the suction transport belt has a multiplicity of small holes through which, in a delimited suction region B, a suction unit (not shown) acts, i.e. sucks upward an electrode element that may be situated there. The suction can be effected permanently or be switched on only in a manner synchronized with the arrival of the respective electrode element.

As a result of the suction, the electrode element 1 comes into frictional engagement with the suction transport belt S and is transported by the latter. As a result of the suction by means of the suction transport belt S, the respective electrode element 1 is accelerated from the first transport speed to the transport speed of the suction transport belt S and the spacing from the succeeding second electrode element 1′ is thus increased. As soon as the respective accelerated electrode element 1 leaves the suction region B of the suction transport belt, it is received by the succeeding transport belt 23, by which it is transported further. The transport speed of the suction transport belt S can be equal to the transport speed of the succeeding transport belt 23 or can be between the first transport speed of the leading transport belt 21 and that of the succeeding transport belt 23 or can even be greater than the transport speed of the succeeding transport belt 23. Optionally, a further transport belt 22 is arranged opposite the first transport belt and in a manner offset with respect thereto, and a further transport belt 24 is arranged opposite the first transport belt and in a manner offset with respect thereto.

FIGS. 8 a, b, c illustrate a sixth exemplary embodiment of the spacing increasing unit 12, which embodiment again follows the principle shown in FIG. 4. FIG. 8a shows the spacing increasing unit in a side view, and FIG. 8b shows it in a plan view of the transport plane of the electrode elements 1. The arrow indicates in each case the transport direction of the electrode elements 1 along the transport path 10. FIG. 8c illustrates the temporal profile of the light barrier signal LS and the temporal profile of the angular or path speed v of the accelerating transport roller pair 25, 26.

A first transport roller pair 3a, an accelerating transport roller pair 25, 26 and a second transport roller pair 3b are arranged in succession along the transport path 10 of the electrode elements, and have different transport speeds; cf. FIG. 8a. The first transport roller pair 3a is driven by a motor M1 at a low angular speed corresponding to a low transport speed v1 of the electrode elements; cf. FIG. 8b. The third transport roller pair is driven by a motor M2 at a higher angular speed corresponding to a higher transport speed v2 of the electrode elements. Alternatively, the first transport roller pair 3a and/or the third transport roller pair 3b can also be driven by a further transport means leading the first transport roller pair 3a and/or respectively by a further transport means succeeding the third transport roller pair 3b, such that there is no need for a dedicated motor M1 and/or respectively M2.

One or both of the transport rollers of the central transport roller pair 25, 26 is/are driven by means of a stepper motor MS, which drives it, until the arrival of an electrode element 1, initially at the angular speed corresponding to the lower transport speed v1 of the first transport roller pair 3a. The modulation of the angular speed of the transport rollers 25, 26 is produced by varying the motor speed of the stepper motor MS coupled thereto.

Located in the region of the accelerating transport roller pair 25, 26 is a light barrier L, cf. FIG. 8a, which registers the arrival of the leading edge of the respective electrode element 1 and reports it to a control unit (not shown) of the spacing increasing unit 12. If an electrode element 1 is registered by the light barrier L, it is already clamped in the accelerating transport roller pair 25, 26. Triggered by the signal LS reported by the light barrier L at the point in time t1, cf. FIG. 8c, the control unit controls the drive of the transport roller pair 25, 26 such that the angular speed of the transport rollers 25, 26 is increased in order to increase the path speed of the transport rollers 25, 26, proceeding from the lower first transport speed v1 at the point in time t1, up to the higher second transport speed v2 at the point in time t2; cf. FIG. 8c. As a result, the respective electrode element is accelerated smoothly and continuously from the first transport speed v1 of the first transport roller pair 3a to the second transport speed v2 of the second transport roller pair 3b. As a result of the acceleration, the spacing between the electrode element 1 that has just been accelerated and the next electrode element 1′ following the latter along the transport path is increased from a spacing a to a larger spacing A. The second transport roller pair transports the respective electrode element further at the higher second transport speed v2.

If the light barrier L subsequently reports to the control unit, at the point in time t3, that it is no longer registering the electrode element 1, the control unit, in reaction thereto, causes the drive of the transport roller pair 25, 26 to reduce the angular speed of the transport rollers 25, 26 again, specifically such that the path speed of the transport roller pair 25, 26 is reduced from the second transport speed v2 back to the first transport speed v1 again; cf. FIG. 8c. This takes place until a point in time t4 lying within the temporal gap that exists until the arrival of the next electrode element 1′, in order that the next electrode element 1′ is again gripped at the first transport speed v1. In the case of this principle of the increase in spacing, the electrode elements are accelerated gently to a higher transport speed. The accelerating transport rollers 25, 26 have a low mass in order that they can rapidly implement the dynamics of acceleration.

Although the first transport roller pair 3a is driven, it has an integrated freewheel in order that the clamping exerted thereby on the electrode element does not counteract the acceleration by the transport roller pair 25, 26. In order to prevent a rotation of the electrode elements during the acceleration thereof, a further such transport roller 26 is arranged on the shaft of the transport roller 26 and is driven in phase with the latter. Analogously, a further such transport rollers 25 is also arranged on the shaft of the transport roller 25 and is driven in phase with the latter, and is used for accelerating the electrode elements: cf. FIG. 8b. Instead of a ramped profile of the angular or path speed of the transport rollers 25, 26, said speed can also be modulated by means of a sinusoidal or similar profile.

Alternatively, the light barrier L can also be arranged upstream of the transport roller pair 25, 26 or upstream of the clamping point thereof along the transport direction. This allows earlier acceleration already at the time at which the leading edge of the electrode element 1 reaches the clamping point. The beginning of the acceleration by means of the transport roller pair 25, 26 is then delayed somewhat with respect to the earlier light barrier signal (at t1) in order that the acceleration only begins when or after the leading edge arrives at the clamping point. The beginning of the reduction of the transport speed is also accordingly delayed with respect to the light barrier signal (at t3).

In comparison with the third and fourth exemplary embodiments, the principal of the sixth exemplary embodiment makes it possible, in a simple manner, to achieve a different increase in spacing of electrode elements with different lengths. For this purpose, the degree or duration of the acceleration is accordingly adapted to the length of the electrode element, e.g. such that the leading edge spacings of the electrode elements with different lengths are identical.

1.-18. (canceled)

19. A device for transporting flat electrode elements of a stream of flat electrode elements having a multiplicity of flat electrode elements, comprising a transport unit designed to transport the flat electrode elements individually one after another along a transport path,
wherein the device has a spacing increasing unit arranged along the transport path of the flat electrode elements and designed to accelerate the flat electrode elements in order to increase the spacing thereof.

20. The device according to claim 19, wherein the device is designed for stacking the flat electrode elements of the stream of flat electrode elements,
wherein the device has a stacking unit designed to stack the flat electrode elements,
wherein the transport unit is designed to transport the flat electrode elements individually one after another along the transport path to the stacking unit, and
wherein the spacing increasing unit is arranged upstream of the stacking unit along the transport path of the flat electrode elements,
wherein the stacking unit has at least one rotatable stacker wheel with a plurality of stacker wheel compartments designed each to receive a flat electrode element.

21. The device according to claim 19, wherein the spacing increasing unit is designed to accelerate a respective first flat electrode element, in particular each first flat electrode element which is transported downstream of a second flat electrode element directly succeeding said first flat electrode element along the transport path, relative to the second flat electrode element in order to increase the spacing thereof.

22. The device according to claim 19, wherein the device in the region of the spacing increasing unit, in particular the spacing increasing unit itself, along the transport path has at least one leading transport means, which makes available a first transport speed for the flat electrode elements transported by means of it, and has at least one succeeding transport means, which makes available a second transport speed for the flat electrode elements transported by means of it, said second transport speed being greater than the first transport speed.

23. The device according to claim 22, wherein the spacing increasing unit has an acceleration unit arranged in the region of the transition between the leading and the succeeding transport means and designed to accelerate the respective first flat electrode element, when it is situated along the transport path between the leading and the succeeding transport means, relative to the respective second flat electrode element in order to increase the spacing thereof.

24. The device according to claim 23, wherein the acceleration unit has a transport roller pair arranged along the transport path in the region of the transition between the leading and the succeeding transport means and having at least one upper transport roller arranged above the transport path of the flat electrode elements and at least one lower transport roller arranged below the transport path of the flat electrode elements, the flat electrode elements being clamped between said transport rollers and the latter being designed to mechanically influence a flat electrode element transported between them in order to accelerate it.

25. The device according to claim 24, wherein the spacing increasing unit is designed to modulate the angular speed of the transport rollers of the transport roller pair in order to accelerate the flat electrode elements.

26. The device according to claim 25, wherein the spacing increasing unit is designed to drive the transport rollers of the transport roller pair by means of a modulatable rotary drive in order to achieve the modulation of the angular speed.

27. The device according to claim 23, wherein the acceleration unit has a suction transport belt arranged above the transport path of the flat electrode elements and designed to lift off a respective flat electrode element, which is being transported at the first transport speed to the transition by the leading transport means, from the leading transport means by suction, to accelerate said flat electrode element upon and/or during the suction and to place it on the succeeding transport means after the acceleration.

28. The device according to claim 19, comprising:
a sensor unit designed for detecting measurement signals of the flat electrode elements, and
an evaluation unit designed for checking the flat electrode elements on the basis of the measurement signal detected for the respective flat electrode element, by means of at least one checking criterion,
wherein the evaluation unit is designed, upon checking the respective flat electrode element, to generate a checking result indicating whether or not the respective flat electrode element satisfies the at least one checking criterion, and
a sorting unit arranged downstream of the sensor unit along the transport path of the flat electrode elements and designed for sorting the flat electrode elements depending on the respective checking result,
wherein the transport unit is designed to transport the flat electrode elements individually one after another along the transport path to the sensor unit and to the sorting unit, and, if present, to the stacking unit.

29. The device according to claim 28, wherein the spacing increasing unit is arranged upstream of the sorting unit along the transport path of the flat electrode elements,
wherein the spacing increasing unit is arranged upstream of the sensor unit along the transport path.

30. A method for transporting flat electrode elements, in particular with the aid of the device according to claim 19, of a stream of flat electrode elements having a multiplicity of flat electrode elements, which in particular were separated from a material web by a separating device in a separating process,
wherein the flat electrode elements of the stream are transported individually one after another along a transport path with the aid of at least one transport unit,
wherein the flat electrode elements are transported to a spacing increasing unit, which accelerates the flat electrode elements in order to increase the spacing thereof, in particular to a processing spacing.

31. The method according to claim 30 for stacking flat electrode elements,
wherein the flat electrode elements are transported individually one after another along the transport path with the aid of the transport unit to a stacking unit designed to stack the flat electrode elements,
wherein the flat electrode elements, before the stacking by the stacking unit, are transported to the spacing increasing unit,
wherein the stacking unit has e.g. at least one rotatable stacker wheel with a plurality of stacker wheel compartments designed each to receive a flat electrode element.

32. The method according to claim 30, wherein the stream of the flat electrode elements is produced with the aid of the following steps:
providing a material web, along the longitudinal direction of which a plurality of flat electrode elements are arranged, and
transporting the material web to a separating device and separating the individual flat electrode elements from the material web by way of the separating device in the context of a separating process,
wherein during the separating process the flat electrode elements are spaced apart from one another in each case by a separating spacing corresponding to the width of a separating line along which the flat electrode elements are separated from the material web during the separating process.

33. The method according to claim 29, wherein the electrode elements are transported individually one after another along the transport path to a sensor unit and to a sorting unit and, if present, then to the stacking unit, comprising the following steps:
transporting the flat electrode elements of the stream to the sensor unit and detecting measurement signals of the flat electrode elements by way of the sensor unit,
checking the flat electrode elements on the basis of the measurement signal detected for the respective flat electrode element, by means of at least one checking criterion,
wherein upon the checking of the respective flat electrode element, a checking result indicating whether or not the respective flat electrode element satisfies the at least one checking criterion is generated,
transporting the flat electrode elements to the sorting unit and sorting the flat electrode elements by way of the sorting unit depending on the respective checking result,
optionally transporting the flat electrode elements, in particular the flat electrode elements left in the stream after the sorting, to the stacking unit arranged downstream of the sorting unit, said stacking unit being designed to stack the flat electrode elements,
wherein the flat electrode elements, before the sorting by the sorting unit and optionally before the stacking by the stacking unit, are transported to the spacing increasing unit, which accelerates the flat electrode elements in order to increase the spacing thereof, in particular to the processing spacing.
